(19) United States
(12) Patent Application Publication
(10) Pub. No.: US 2026/0308953 A1
(43) Pub. Date: Oct. 8, 2026

(54) Exterior Door Handle for Attachment to a Side Door of a Motor Vehicle

(71) Applicant: Bayerische Motoren Werke Aktiengesellschaft, Muenchen (DE)

(72) Inventors: Steve BREUNINGER, Gauting (DE); Jacobo DOMINGUEZ OJEA, Muenchen (DE); Alexander SCHNEIDER, Muenchen (DE)

(21) Appl. No.: 18/875,404

(22) PCT Filed: Jun. 5, 2023
(86) PCT No.: PCT/EP2023/064985

§ 371 Date: Dec. 16, 2024

(30) Foreign Application Priority Data
Jun. 27, 2022 (DE) 10 2022 115 888.8

(51) Int. Cl. E05B 81/76; B60Q 1/24; E05B 85/10

(52) U.S. Cl. CPC E05B 81/77; B60Q 1/247; E05B 85/10

(57) ABSTRACT

A side door of a motor vehicle has an exterior door handle which extends, proceeding from the side door in a state in which the side door is attached to the motor vehicle, outward in a motor vehicle width direction and upward in a motor vehicle height direction. The exterior door handle has a sensor disposed and configured to detect a hand situated at a predetermined distance from and/or on the exterior door handle.

### BACKGROUND AND SUMMARY

The present disclosure relates to an exterior door handle for attachment to a side door of a motor vehicle, and to a side door of a motor vehicle comprising the exterior door handle. Furthermore, a motor vehicle, e.g., an automobile or a commercial vehicle, such as a truck, having the side door can be provided.

Side doors of motor vehicles may be equipped with surface-flush door handles, integrated door handles or alternatively with electrical systems in which actuation of a locking mechanism of the door does not require mechanical action on the part of the driver by pulling a door handle.

In the case of electrical systems with electronically locked side doors of motor vehicles, it is known from the prior art that by actuating a pushbutton on the side door, e.g., in the region on a B-pillar or C-pillar, a locking mechanism of the side door is unlocked and the side door opens.

In one specific configuration, conventionally a driver's key or a driver's telephone that can be used as a key is recognized by way of wireless communication with the side door and the button on the side door lights up when the key or the telephone is situated in a certain region around the side door. As a result of the pushbutton being actuated by the driver, the side door is unlocked and comes open slightly.

An exterior door handle attached to the side door below the pushbutton enables the driver then to fully open the already unlocked and slightly open side door by pulling on the exterior door handle.

Electrical systems can thus be implemented with the aid of a so-called winglet or exterior door handle arranged for example in the region of a channel strip of the side door. This winglet can contribute to assisting the door opening operation.

Touching the pushbutton on the side door means, however, that the driver firstly has to exert force for this and secondly has to press the pushbutton in a first step and can only open the door once an unlocking operation has taken place.

Against the background of this prior art, the object of the present disclosure consists in specifying an improved device which is suitable for enhancing the prior art described above.

Accordingly, the object is achieved by a side door of a motor vehicle. That is to say that a side door for a motor vehicle, such as an automobile, for example, is provided.

The side door comprises an exterior door handle, which extends, proceeding from the side door in a state in which the side door is attached to the motor vehicle, outward in a motor vehicle width direction and upward in a motor vehicle height direction.

At an entry region of the motor vehicle, e.g., in a region of a driver's seat, a passenger seat and/or a rear seat bench, a side door can be understood to mean an attachable door which can be moved in particular by pivoting or displacement from a closed position, in which the side door closes the entry opening, into an open position, in which the side door gives free access to the entry opening, and vice versa.

In the state in which the side door is attached to the motor vehicle, a pivot axis for opening and closing the side door may run parallel to the motor vehicle height direction or a motor vehicle longitudinal direction; this is then a so-called gullwing door.

If the side door is a sliding door, then a movement direction when opening and closing the side door may run along or parallel to the motor vehicle longitudinal direction.

If the side door has a window, then a window strip may run along the motor vehicle longitudinal direction.

In other words, depending on the type of side door, it may be inferred from the side door itself how the latter is to be attached or is attachable to the motor vehicle, such that the positions of the motor vehicle longitudinal direction, motor vehicle width direction and motor vehicle height direction are recognizable and defined on the basis of the side door itself.

In other words, generic side doors unambiguously define the positions of the motor vehicle longitudinal direction, motor vehicle width direction and motor vehicle height direction for the state in which the side door is attached to the motor vehicle, without the side doors already having been fitted or attached to the motor vehicle.

The exterior door handle can have a sensor arranged and configured to detect a hand situated at a predetermined distance from and/or on the exterior door handle.

In the present case, an exterior door handle can be understood to mean the component referred to as winglet in the introduction. In the present case here the side door of the motor vehicle can be a side door with an electronic locking system (so-called E-lock), that is to say that no mechanical force is transmitted to the locking system by actuation, in particular pulling on the exterior door handle, in order to unlock the locking system. Rather, the sensor can output an electrical signal to the side door, in particular to the locking system thereof, such that the side door is openable as a result of being touched and/or approached by the hand. The hand is a human hand. It is conceivable for a so-called “door presenter” to be provided. The latter can be configured to slide open the side door from the closed state either into a preliminary latch or else completely. The “door presenter” can thus slide the side door into the preliminary latch so that it is held there.

This configuration in which the sensor is fitted in or on the exterior door handle itself affords a large number of advantages in comparison with the above-described prior art in which the sensor is located on the motor vehicle outer skin, in particular in the B-pillar or C-pillar.

Inter alia, opening the side door becomes possible more easily or more ergonomically. In particular, touching a mechanical pushbutton external to the exterior door handle, a flap or a sensor on the motor vehicle exterior skin can be obviated, such that firstly the user does not have to exert force for this and secondly it is no longer the case that the user has to press the button in a separate step before pulling open the side door and is only able to pull open the door once an unlocking operation has taken place.

Moreover, servicing or maintenance is facilitated since if the sensor has a defect, all that needs to be replaced is an attachment, i.e., the exterior door handle, rather than part of the motor vehicle exterior skin.

Possible developments of the side door, and in particular of the exterior door handle, are described in detail below.

The sensor can be a proximity sensor, in particular a capacitive sensor, or a mechanical or electromechanical, optionally inductive, pushbutton. It is also conceivable, additionally or alternatively, for the sensor to be configured to detect movement of the hand. In this case, the side door can be opened by means of gesture control. It is also conceivable, additionally or alternatively, for the sensor to have a pushbutton, i.e., for the sensor to be configured to detect a deformation, e.g., caused by the hand.

A handle depression or handle surface formed by the exterior door handle, in particular in the motor vehicle width direction, between the exterior door handle and the side door, in the state in which the side door is attached to the motor vehicle, can be open upward in the motor vehicle height direction and toward the front and back in a motor vehicle longitudinal direction. Alternatively, it is conceivable that the handle depression or handle surface formed by the exterior door handle between the exterior door handle and the side door, in the state in which the side door is attached to the motor vehicle, can be open downward in the motor vehicle height direction and toward the front and back in a motor vehicle longitudinal direction. This form affords advantages with regard to an air resistance or alternatively with regard to water drainage and potential soiling of the motor vehicle.

The sensor can be arranged and configured to detect the hand when the latter is situated in the handle depression. In other words, it is conceivable that the side door can be opened by reaching into the handle depression. This is advantageous, in particular also in comparison with the above-described prior art, since the process of opening the side door can therefore be carried out more ergonomically or more easily. The side door can then be opened or unlocked in one step by a hand and then opened by pulling on the exterior door handle. However, additionally or alternatively, the sensor can also function toward the exterior, i.e., detect when the hand comes from outside into the vicinity of the exterior door handle.

The exterior door handle can have an illumination device arranged and configured to emit light visible to the human eye to surroundings of the exterior door handle.

The light visible to the human eye can be understood to mean a visible portion of the electromagnetic spectrum which comprises or consists of a wavelength range of 400 nm to 780 nm.

The illumination device can have a light source, e.g., having one or more LEDs (light-emitting diode) with a light guide, which are arranged such that in the state in which the side door is attached to the motor vehicle, the light emitted by the light source to the surroundings of the exterior door handle via the light guide is emitted upward in the motor vehicle height direction.

The light source can be arranged laterally with respect to an elongate cutout in the exterior door handle, a longitudinal direction of the cutout in the state in which the side door is attached to the motor vehicle being able to extend along the motor vehicle longitudinal direction.

The light guide can be arranged below, i.e.,-in the state in which the side door is attached to the motor vehicle-in the motor vehicle height direction beneath, the cutout.

The exterior door handle can have a partition wall which is arranged in the cutout between the surroundings of the exterior door handle and the light guide, in particular above the light guide in the motor vehicle height direction, and subdivides the cutout into sub-regions.

The cutout can be closed by a transparent or matt-finished surface.

This affords the advantage that illumination can be provided along an upper part of the exterior door handle, without a user who is looking at the motor vehicle from a certain distance and/or at a certain angle looking directly at the light guide.

The side door can have a locking mechanism and be configured to unlock the locking mechanism when the hand is detected by means of the sensor. The locking mechanism can be the electronic locking mechanism described in the introduction.

The side door can be configured to control the illumination device depending on a state of the locking mechanism. The different states can be represented in color, for example by means of at least one RGB-LED.

One embodiment is described below with reference to FIGS. 1 to 4.

### BRIEF DESCRIPTION OF THE DRAWINGS

FIG. 1 schematically shows a perspective view of a side door of a motor vehicle with an exterior door handle arranged thereon with a viewing direction from the outside relative to the motor vehicle;

FIG. 2 schematically shows an arrangement of electronic components of the exterior door handle from FIG. 1;

FIG. 3 schematically shows a perspective view of the exterior door handle with a viewing direction from above relative to the motor vehicle; and

FIG. 4 schematically shows a perspective view of part of the exterior door handle with a viewing direction from above relative to the motor vehicle.

### DETAILED DESCRIPTION OF THE DRAWINGS

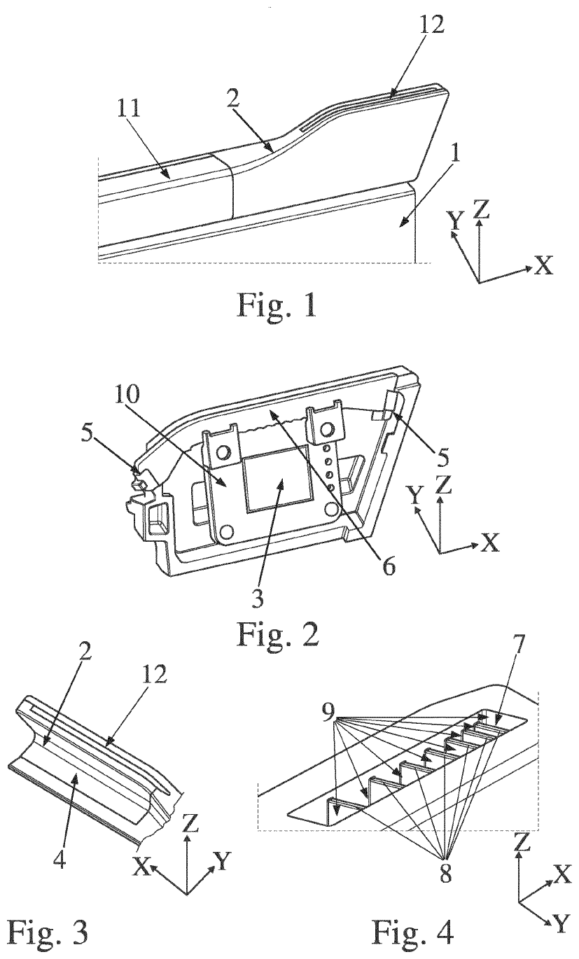

In the following description of the figures, the same reference signs are used for the same components or objects illustrated in FIGS. 1 to 4.

FIGS. 1 to 4 each illustrate a Cartesian coordinate system, the X-axis of which points in a motor vehicle longitudinal direction, the Y-axis of which points in a motor vehicle width direction and the Z-axis of which points in a motor vehicle height direction. The motor vehicle longitudinal direction X runs from a front to a rear of the motor vehicle (not illustrated in further detail) and the motor vehicle width direction Y runs from an interior or a passenger compartment of the motor vehicle to an exterior of the motor vehicle.

Furthermore, FIGS. 1 to 4 illustrate a state in which the side door 1 is attached to the motor vehicle.

The side door 1 comprises an exterior door handle 2, which extends, proceeding from the side door 1, outward in the motor vehicle width direction Y and upward in a motor vehicle height direction Z, i.e., from the inner area outward and from the bottom upward, such that a handle depression 4 is formed between the exterior door handle 2 and the side door 1.

The handle depression 4 formed by the exterior door handle 2 between the exterior door handle 2 and the side door 1 is open upward in the motor vehicle height direction Z and toward the front and back in a motor vehicle longitudinal direction X. It would also be conceivable to rotate the exterior door handle 2 by 180° about the motor vehicle width direction Y, such that the handle depression 4 is open downward.

It is possible to reach into this handle depression 4 in order to open the side door 1, as described in detail below. Moreover, an air stream flowing along the side door 1 can pass through the handle depression 4.

Furthermore, the side door 1 comprises a channel strip 11; the latter is illustrated merely by way of example in FIG. 1 and the exterior door handle 2 or the winglet can likewise be used for systems without channel strips.

A printed circuit board 10 is arranged in the exterior door handle 2, and a sensor 3 and an illumination device comprising a light source 5 and a light guide 6 are in turn arranged on the printed circuit board.

The light source 5 and the light guide 6 arranged laterally with respect thereto in the illumination device are arranged such that the light emitted by the light source 5 to the surroundings of the exterior door handle 2 via the light guide 6 is emitted upward in the motor vehicle height direction Z. The light is a light visible to the human eye.

For this purpose, the light source 5 is arranged laterally, and the light guide 6 is arranged underneath, with respect to an elongate cutout 7 in the exterior door handle 2, a longitudinal direction of the cutout 7 extending along the motor vehicle longitudinal direction X. In the cutout 7, one or more partition walls 8 can be arranged above the light guide 6, i.e., between the surroundings of the exterior door handle 2 and the light guide 6, and subdivide the cutout 7 along the longitudinal direction thereof into a plurality of sub-regions 9. This arrangement makes it possible to prevent the light source 5 from being looked at directly from the outside. The transparent regions or the transparent region of the cutout 7 through which the light passes can be embodied so as to be structured or highly lustrous on the inner and/or outer surface.

The elongate cutout 7 can have a length of 1 mm to 70 mm, in particular 45 mm, in the motor vehicle longitudinal direction X. The elongate cutout 7 can have a width of 1 mm to 7 mm, in particular 4.5 mm, in the motor vehicle width direction Y. The elongate cutout 7 can have a depth of between 1 mm and 5 mm, in particular 3.5 mm, in the motor vehicle height direction Z. The partition walls 8 can end 0.5 mm to 50 mm, in particular 1 mm, below a transparent or matt-finished surface 12 (not illustrated in FIG. 4 for elucidation purposes) that closes the cutout 7. The partition walls 8 can have a spacing of 5 mm to 20 mm, in particular 10 mm, in the motor vehicle longitudinal direction X. These dimensions mentioned above are merely a non-exhaustive enumeration of examples which do not restrict the disclosure in any way.

The sensor 3 is arranged and configured to detect a hand situated at a predetermined distance from and/or on the exterior door handle 2, particularly when the hand is situated in the handle depression 4.

To put it more precisely, in the present case, the sensor 3 is a proximity sensor, in particular a capacitive sensor, which is arranged on an outer side or a side of the printed circuit board 10 facing away from the handle depression 4. However, it would also be conceivable for the sensor 3 to face the inner side, the top side or the underside of the exterior door handle 2. It would also be conceivable to arrange the sensor 3 on the opposite inner side of the printed circuit board 10, such that the sensor faces the handle depression 4.

In the event of reaching into the handle depression 4 by means of the sensor 3, a control signal can be output by the sensor 3 to a locking mechanism (not illustrated) of the side door 1 for the purpose of opening the side door 1, such that the locking mechanism is transferred into a position or state in which the locking mechanism is unlocked. The side door 1 can then be opened by pulling on the exterior door handle 2.

In order that the user or driver who opens the side door 1 in the manner described above is given feedback about the current state of the locking mechanism in the sense of a user-guided interaction, the illumination device, i.e., in particular the light source 5, can be controlled by the side door 1 depending on a current state of the locking mechanism. In this case, each state can be assigned a color with which the light from the light source 5 is emitted.

### LIST OF REFERENCE CHARACTERS

1 side door
2 exterior door handle
3 sensor
4 handle depression
5 light source
6 light guide
7 elongate cutout or opening
8 partition walls
9 sub-regions
10 printed circuit board
11 channel strip
12 transparent or matt-finished surface

1-10. (canceled)

11. A side door of a motor vehicle, comprising:
an exterior door handle which extends, proceeding from the side door in a state in which the side door is attached to the motor vehicle, outward in a motor vehicle width direction and upward in a motor vehicle height direction;
wherein the exterior door handle has a sensor disposed and configured to detect a hand situated at a predetermined distance from and/or on the exterior door handle.

12. The side door according to claim 11, wherein the sensor is a proximity sensor or a mechanical pushbutton or an electromechanical pushbutton.

13. The side door according to claim 11, wherein a handle depression formed by the exterior door handle between the exterior door handle and the side door, in the state in which the side door is attached to the motor vehicle, is open upward or downward in the motor vehicle height direction and toward a front and a back in a motor vehicle longitudinal direction.

14. The side door according to claim 13, wherein the sensor is disposed and configured to detect the hand when the hand is disposed in the handle depression.

15. The side door according to claim 11, wherein the exterior door handle has an illumination device disposed and configured to emit light visible to a human eye to a surrounding of the exterior door handle.

16. The side door according to claim 15, wherein the illumination device has a light source with a light guide which are disposed such that in the state in which the side door is attached to the motor vehicle, light emitted by the light source to the surrounding of the exterior door handle via the light guide is emitted upward in the motor vehicle height direction.

17. The side door according to claim 16, wherein:
the light source is disposed laterally with respect to an elongate cutout in the exterior door handle, wherein a longitudinal direction of the cutout, in the state in which the side door is attached to the motor vehicle, extends along a motor vehicle longitudinal direction;
the light guide is disposed below the elongate cutout; and
the exterior door handle has a partition wall which is disposed in the elongate cutout between the surrounding of the exterior door handle and the light guide and subdivides the elongate cutout into sub-regions.

18. The side door according to claim 17, wherein the elongate cutout is closed by a transparent or a matt-finished surface.

19. The side door according to claim 11, wherein the side door has a locking mechanism and is configured to unlock the locking mechanism when the hand is detected by the sensor.

20. The side door according to claim 19, wherein the exterior door handle has an illumination device disposed and configured to emit light visible to a human eye to a surrounding of the exterior door handle and wherein the side door is configured to control the illumination device depending on a state of the locking mechanism.
